(19) United States
(12) Patent Application Publication
(10) Pub. No.: US 2008/0248700 A1
(43) Pub. Date: Oct. 9, 2008

(54) Contact Arrangement

(76) Inventors: Reinhold Baertl, Lappersdorf (DE); Dieter Dohnal, Lappersdorf (DE); Dieter Geiger, Deuerling (DE); Albert Schmidbauer, Roding (DE)

Correspondence Address: K.F. ROSS P.C., 5683 RIVERDALE AVENUE, SUITE 203 BOX 900, BRONX, NY, 10471-0900, US

(21) Appl. No.: 10/574,156

(22) PCT Filed: Jul. 5, 2005
(86) PCT No.: PCT/EP2005/007209

§ 371 Date: Mar. 28, 2006

(30) Foreign Application Priority Data
Aug. 26, 2004 (DE) 10 2004 041 317.7

(51) Int. Cl. H01R 13/02

(52) U.S. Cl. 439/889

(57) ABSTRACT

The invention relates to a contact arrangement in which an electrical contact of U-shaped construction is fixed in common by two contact holders, which surround it at the top and bottom, and selectably also upper and lower screening caps, by means of two pins which go through corresponding bores not only of the described components, but also of the insulating rod at which the fastening shall take place.

The invention relates to a contact arrangement with a fixed electrical contact, which is fastened to an insulating rod, for a step switch or tap changer.

Step switches and tap changers are known apparatus for switching over between different winding taps of a regulating transformer for voltage regulation. They have stationary contacts which are electrically connected with the individual winding taps of a regulating transformer and are usually arranged in phases on circular tracks disposed one above the other. In each horizontal plane electrical connection can be made with the stationary contacts by a movable contact, usually a contact bridge, connected with the electrical load shunt. The stationary contacts are in that case fastened to vertically extending insulating rods of hard paper or glass-fiber-reinforced synthetic material or also in the wall of insulating cylinders.

The fastening to insulating rods is hitherto usually carried out in that not only the corresponding insulating rod itself, but also a fastening part of the stationary contact are provided with respective bores and this contact arrangement is tightened together by screws and nuts. Such a contact arrangement with a screw connection is known from FIG. 1 of AT-PS 187991. However, the disadvantage of this fastening, which is simple in itself, consists in that due to the metallic fastening means penetrating the insulating rods the voltage resistance of the entire step switch or tap changer is impaired.

Numerous proposals have already become known for remedying this problem. The mentioned AT-PS 187991 itself describes a further contact arrangement in which clamping members are provided, which embrace the respective insulating rods and which are screw-connected outside these insulating rods, so that no metallic fastening means penetrate the insulating rods themselves. A quite similar solution was subsequently proposed once again in AT-PS 315302. Bores through the insulating rods can indeed be avoided by that, but metallic fastening means—even if outside the insulating rods—are still present; the disadvantage influence thereof on the voltage resistance thus continues to be present.

A further contact arrangement is known from AT-PS 382476, wherein a sleeve is provided at the contact to be fastened, the sleeve having on one side a collar with a diameter greater than the bore diameter of the respective insulating rod. On the other side of the insulating rod the sleeve of the contact to be fastened has an annular groove in which a slotted ring of plastics material is placed. However, this arrangement has not been able to gain acceptance in practice. Insulating material rods usually shrink during the necessary drying of the respective step switch or tap changer prior to being placed in operation; in the case of this known contact arrangement the individual contacts then loosen due to the fastening purely by shape-locking coupling, which is not desirable.

A contact arrangement as well as an associated fastening method are known from DE-PS 3801151 and 3801152, wherein the contact is held by permanent deformation of its shank on the outer side, stated more precisely by expansion of bores specifically provided for that purpose. This is relatively costly and requires a special tool for expanding the described bores and beyond that similarly enables only fastening in a shape-locking manner. Finally, disassembly of this contact arrangement without destruction is also not possible.

DE-GM 9010730 proposes a similar contact arrangement; in this case the shank of the contact is weakened in its cross-section in a defined region and a bulge-like thickening of the shank is achieved at this location by upsetting from the outside, whereby fixing is effected. A special tool is indeed not required for the described upsetting from outside—a hammer suffices—but here, too, there is the disadvantage that, apart from the connection which is again only a shape-locking coupling, disassembly is similarly possible only by destruction of the contact.

DE-PS 4236528 describes a further possibility of fastening a contact by a transverse pin, which penetrates the contact shank, and locking means co-operating therewith. This connection is detachable without destruction, can also be executed to be force-locking and is additionally also suitable for simultaneous fastening of screening rings. Nevertheless, it was not able gain acceptance, because it is of relatively complicated construction and requires a multiplicity of individual parts produced with a high degree of accuracy relative to one another.

It is accordingly the object of the invention to indicate a contact arrangement of the kind stated in the introduction in which a fixed electrical contact can be fastened to an insulating rod without impairment of the voltage strength taking place due to metallic fastening parts, wherein the contact arrangement moreover is of simple and economic construction, is secured against loosening of the fixed contact and, in addition, can be demounted again without destruction.

This object is fulfilled by a contact arrangement with the features of the first patent claim. The subclaims relate to particularly advantageous developments of the invention.

According to the invention the contact arrangement of the kind stated in the introduction consists, apart from the actual contact which is to be fastened to an insulating rod, additionally of a two-part contact holder of insulating material as well as pins, similarly of insulating material, for fastening. According to the invention the actual contact is of U-shaped construction. The contact arrangement according to the invention has a number of advantages: no metallic parts of any kind are required for fastening, the entire arrangements consists of only a few parts which can be produced in simple manner and, nevertheless, a secure fastening is possible without special tools. The fastening according to the invention ensures, even in the case of possible shrinkage of the insulating rod or later vibrations in operation, a reliable, secure fastening; finally—again without a special tool—demounting in simple manner and without destruction is possible at any time.

According to an advantageous development of the invention additional screening caps, which surround the contact at both sides in longitudinal direction of the insulating rod, are fastenable therewith in simple manner.

The invention will be explained in more detail in the following by way of example with reference to drawings, in which:

FIG. 1 shows a contact arrangement according to the invention in side illustration,

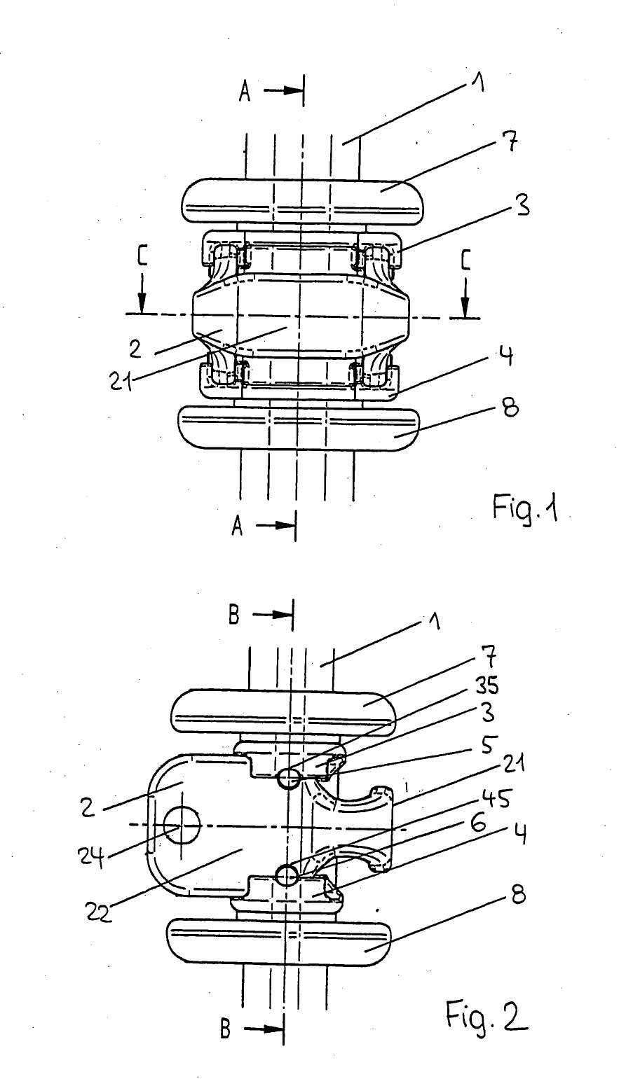

FIG. 2 shows this contact arrangement rotated horizontally through 90°,

FIG. 3 shows a section in the plane A-A through this contact arrangement,

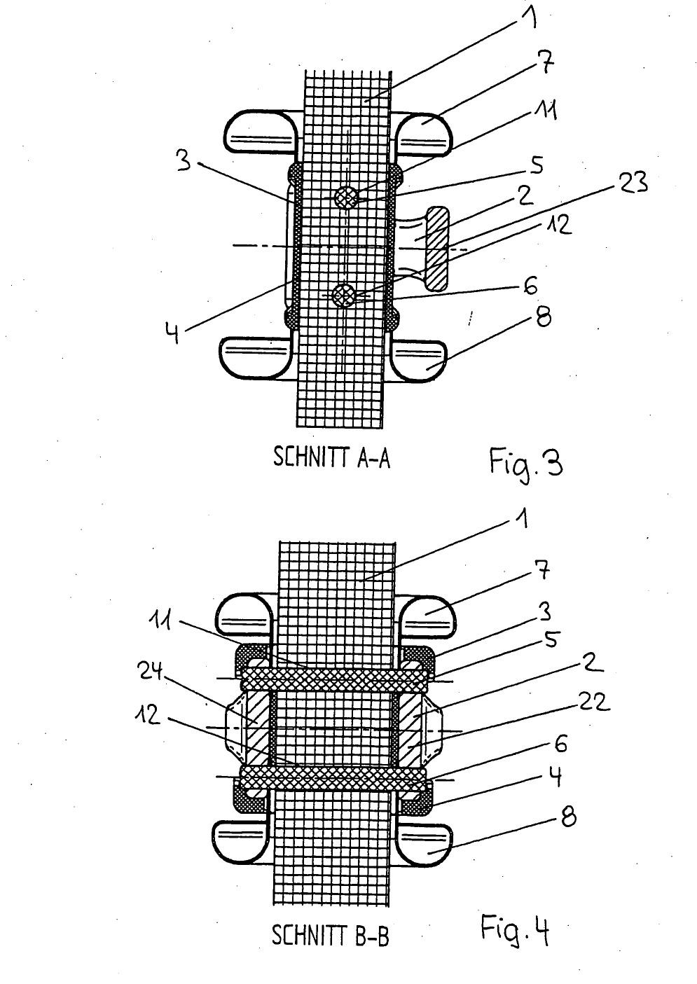

FIG. 4 shows a section in the plane B-B through this contact arrangement,

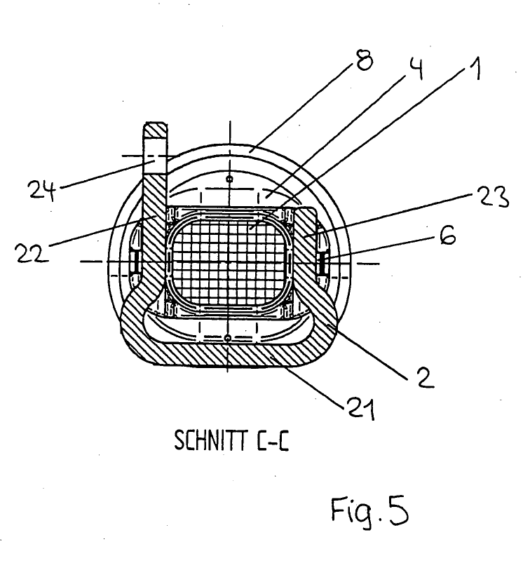

FIG. 5 shows a section in the plane C-C through this contact arrangement,

FIG. 6 shows a perspective illustration of the contact arrangement,

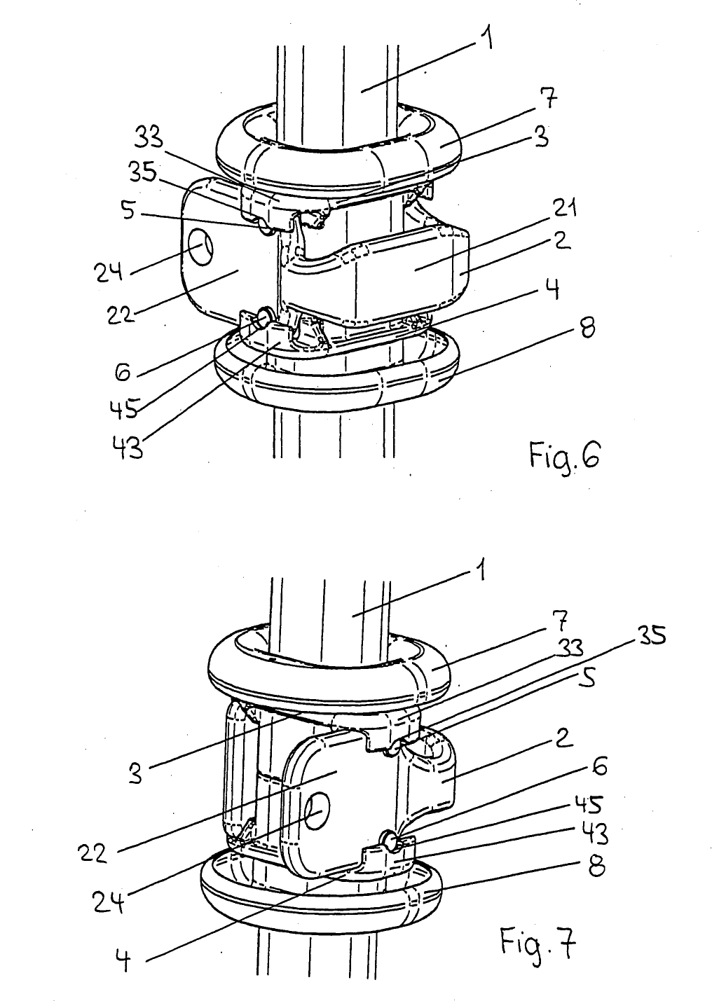

FIG. 7 shows a corresponding illustration again turned horizontally through 90°,

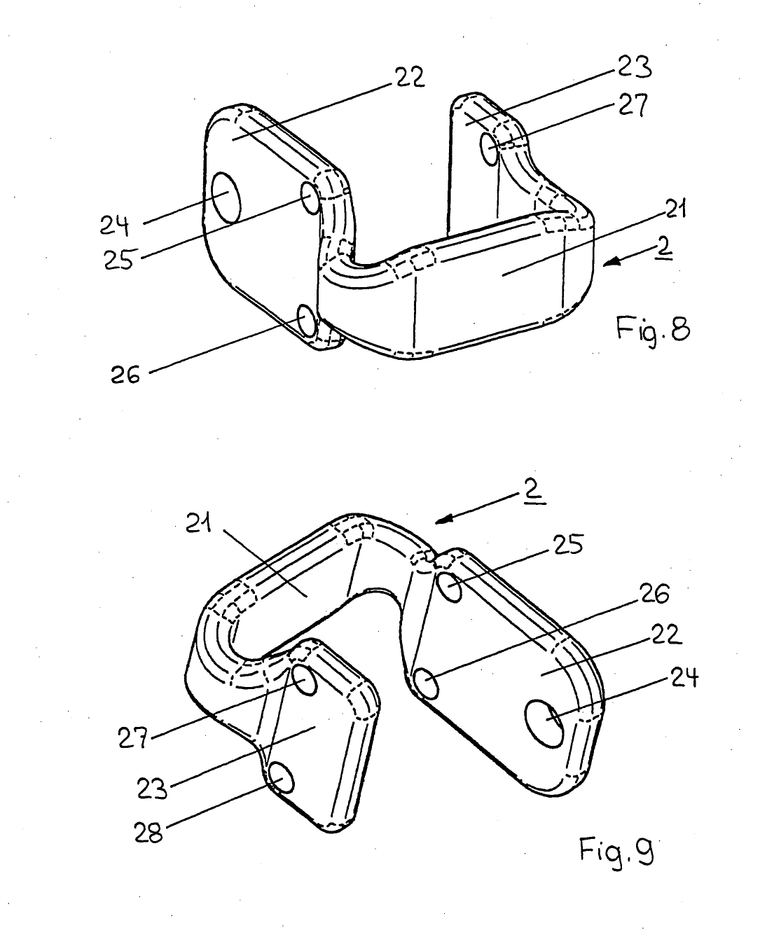

FIG. 8 shows a contact by itself, in perspective illustration,

FIG. 9 shows this contact turned through 180°,

FIG. 10 shows an upper contact holder by itself, in perspective illustration,

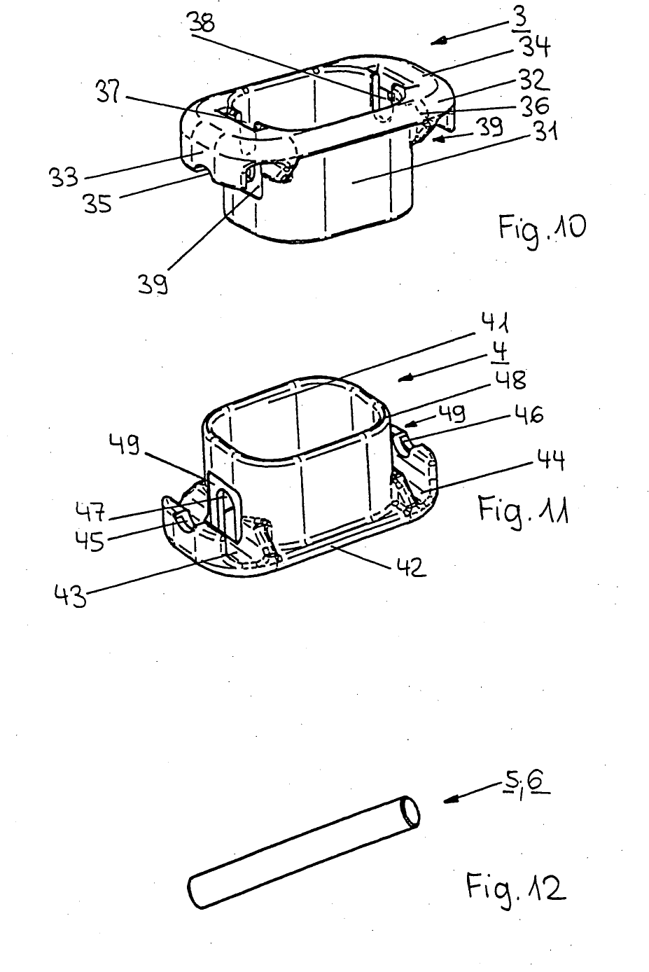

FIG. 11 shows a lower contact holder by itself, in perspective illustration,

FIG. 12 shows a pin for fastening,

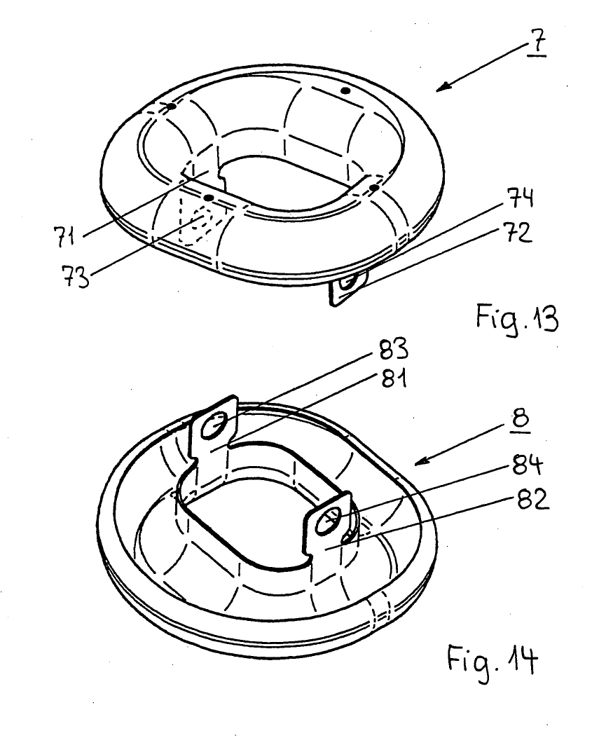

FIG. 13 shows an upper screening ring by itself, in perspective illustration, and

FIG. 14 shows a lower screening ring by itself, in perspective illustration.

In FIGS. 1 to 7, which show the entire contact arrangement according to the invention in mounted state, for reasons of clarity not all reference numerals are entered.

In FIGS. 1 to 7, which illustrate the entire contact arrangement, there is shown at the outset an insulating rod 1 to which the contact arrangement according to the invention is to be fastened. The individual parts of the contact arrangement according to the invention are illustrated separately in FIGS. 8 to 14.

The insulating rod 1 has for each contact arrangement which is to be fastened a respective upper fastening bore 11 and a respective lower fastening bore 12. The contact 2, which is of U-shaped construction, is arranged at the insulating rod 1. It has a contact region 21; that is the region in which electrical connection can be made at the top and bottom by a movable contact (not illustrated). It additionally has a long limb 22 and a short limb 23, a connecting bore 24—with which the electrical connecting line (not illustrated here) for the respective winding tap of the regulating transformer is connectable—being disposed in the long limb 22. The long limb 22 additionally has an upper part fastening bore 25 and a lower fastening bore 26. The short limb 23 extends on the opposite side of the insulating rod 1 parallel to the long limb 22 and similarly has an upper fastening bore 27 as well as a lower fastening bore 28. The fastening bores 25, 27 and 26, 28 correspond with the fastening bores 11 and 12 which penetrate the insulating rod 1. At the top the contact 2 is fixed by an upper contact holder 3. The contact holder 3 has a guide shank 31, the internal dimensions of which correspond with the external dimensions of the insulating rod 1; it is pushed onto this insulating rod 1. It additionally has an encircling collar 32, at which lateral, integrally formed contact mounts 33 and 34 disposed opposite one another are provided. In the mounted state the upper region of the long limb 22 of the contact 2 rests in the contact mount 33 and the upper region of the short limb 23 correspondingly rests in the contact mount 34. Counter-bearings 35, 36, which are similarly disposed opposite one another, for a pin 5, which is explained still later, are provided in the region of the contact mounts 33, 34. Finally, a bore 37 is disposed there and, on the opposite side, a further bore 38 through the guide shank 31.

From the bottom the contact 2 is surrounded in the mounted state by a lower contact holder 4. The lower contact holder 4 is constructed identically to the already described upper contact holder 3; it is pushed from below onto the contact rod 1. It again has in entirely analogous manner a guide shank 41 at which is integrally formed an encircling collar 42, which in turn has lateral integrally formed contact mounts 43 and 44. The lower region of the long limb 22 rests in the contact mount 43 and the lower region of the short limb 23 rests in the contact mount 44. Counter-bearings 45 and 46 and bores 47 and -opposite thereto—48 are again disposed in this region.

For fastening, merely an upper pin 5 and a lower pin 6, both of insulating material, for example glass-fiber synthetic material are now required. The upper pin 5 is led horizontally from outside through the upper fastening bore 25 of the long limb 22 of the contact 2, further through the bore 37 of the upper contact holder 3, on through the upper fastening bore 11 of the insulating rod 1, further through the bore 38 of the upper contact holder 3 on the opposite side and finally through the upper fastening bore 27 of the opposite short limb 23 of the contact 2 and then points outwardly again on the opposite side.

Correspondingly, the lower pin 6 is led initially through the lower fastening bore 26 of the long limb 22 of the contact 2, further through the bore 47 of the lower contact holder 4, on through the lower fastening bore 12 of the insulating rod 1, then through the bore 48 on the opposite side of the lower contact holder 5 and finally through the lower fastening bore 28 in the short limb 23 of the contact 2, before it similarly goes outwardly again on the opposite side.

A reliable fastening of the contact 2 to the insulating rod 1 is thus given. Due to the contact holders 3 and 4 arranged at the top and the bottom on both sides the contact 2 is reliably fixed and firm under all operating conditions. The pins 5 and 6 are dimensioned in their length in such a manner that they rest laterally on the corresponding counter-bearings 35, 36 for the upper pin 5 or counter-bearings 45, 46 for the lower pin 6.

According to an advantageous development of the invention the outer regions of the counter-bearings 35, 36 are vertically displaced by a small amount relative to the upper fastening bore 11 and those of the counter-bearings 45, 46 relative to the lower fastening bore 12, so that, due to the resilience—which is present within certain limits—of the components the introduced pins 5 and 6 are pressed during mounting in axial direction against the outer regions of the counter-bearings 35, 36 or 45, 46 until in the final mounting position these counter-bearings ‘snap closed’ in their outer region and the respective pin is thereby axially secured. This prevents unintended slipping out.

According to a development of the invention an upper screening cap 7 and a lower screening cap 8 are additionally provided. The open sides of the screening caps 7 and 8 respectively face the contact member 2. The upper screening cap 7 has a first fastening strap 71 and, opposite thereto, a second fastening strap 72; respective bores 73 and 74 are disposed therein. The upper screening cap 7 is pushed from above onto the insulating rod 1 so that the fastening straps 71, 72 point downwardly. In entirely analogous manner the identically constructed screening cap 8 in the pushed-on state has an upwardly pointing first fastening strap 81 and, opposite thereto, a second fastening strap 82, respective bores 83 and 84 again being disposed therein. The fastening straps 71, 72 or 81, 82 as well as the bores 73, 74 or 83, 84 disposed therein are dimensioned in such a manner that the fastening pins 5 and 6 in the mounted state are also led through these bores, whereby the screening caps 7 and 8 in common with the contact 2 and upper contact holder 3 as well as lower contact holder 4 are fastened to the insulating rod 1 without additional fastening means being required. The electrical contact between the respective screening cap 7 or 8 and the contact 2 is achieved by means of the respective pre-bent fastening straps 71, 72 or 81, 72. Moreover, the side edges of the straps 71, 72 or 81, 82, which are guided in the pockets 39, 49 of the respective contact holder 3,4 so as to be coupled in mechanically positive manner, prevent lateral twisting.

In practice, the contact 2 is, for mounting, brought to the corresponding side of the insulating rod 1 to which it is to be fastened. Subsequently, the upper contact holder 3 is pushed on to the insulating rod 1 from above and the lower contact holder 4 from below. The two contact holders 3 and 4 fix the contact 2. Subsequently, the upper screening cap 7 can be pushed onto the insulating rod from above and the lower screening cap 8 from below.

The following bores are aligned in an upper horizontal plane in the setting provided for fixing:

Upper fastening bore 25 of the contact 2, bore 37 of the upper contact holder 3, bore 73 of the screening cap 7, upper fastening bore 11 of the insulating rod 1, bore 74 of the upper screening cap 7, bore 38 of the upper contact holder 3 and upper fastening bore 27 of the contact 2.

The upper pin 5 is horizontally pushed in through these aligned bores. In the pushed-in state the upper pin 5 rests laterally by its free ends on the inner counter-bearing 35 or—on the other side—the inner counter-bearing 36.

Correspondingly, the following bores are aligned in a lower horizontal setting:

Lower fastening bore 26 of the contact 2, bore 47 of the lower contact holder 4, bore 83 of the lower screening cap 8, lower fastening bore 12 of the insulating rod 1, bore 84 of the lower screening cap 8, bore 48 of the lower contact holder 4 and lower fastening bore 28 of the contact 2.

The lower pin 6 is pushed in horizontally through these aligned bores. In the pushed-in state the lower pin 6 rests laterally by its free ends on the inner counter-bearing 45 or—on the other side—the inner counter-bearing 46.

Overall, the explained contact arrangement according to the invention has, apart from the actual conductive contact 2, which is fastened to the insulating rod 1, thus only three different further components:

a contact holder, which can, for example, be produced economically as an injection-molded part from plastics material and which is pushed onto the insulating rod 1 not only as upper contact holder 3, but also—turned through 180 degrees—as identical lower contact holder 4,

a screening cap, which can easily be made from sheet metal and which is pushed onto the insulating rod not only as upper screening cap 7, but also—turned through 180 degrees—as identical lower screening cap 8, and

a simple pin of insulating material, which serves not only as upper fastening pin 5, but also as lower fastening pin 6.

### Reference Numeral List

1 insulating rod
   11 upper fastening bore
   12 lower fastening bore
2 contact
   21 contact region
   22 long limb
   23 short limb
   24 connecting bore in 22
   25 upper fastening bore in 22
   26 lower fastening bore in 22
   27 upper fastening bore in 23
   28 lower fastening bore in 23
3 upper contact holder
   31 guide shank
   32 encircling collar
   33 integrally formed contact mount for 22
   34 integrally formed contact mount for 23
   35 counter-bearing
   36 counter-bearing
   37 bore
   38 bore
   39 pocket
4 lower contact holder
   41 guide shank
   42 encircling collar
   43 integrally formed contact mount for 22
   44 integrally formed contact mount for 23
   45 counter-bearing
   46 counter-bearing
   47 bore
10
48 bore
49 pocket
5 upper pin
6 lower pin
7 upper screening cap
71 fastening strap
72 fastening strap
73 bore
74 bore
7 lower screening cap
81 fastening strap
82 fastening strap
83 bore
84 bore

1. Contact arrangement with a fixed electrical contact which is fastened to an insulating rod and has a contact region at which electrical connection can be made, characterized in that the insulating rod (1) has an upper fastening bore (11) and a lower fastening bore (12), the fixed contact (2) is of U-shaped construction in such a manner that it has the contact region (21) in the middle and a respective limb (22, 23) on each side thereof, the two limbs (22, 23) each have two fastening bores (25, 26; 27, 28) corresponding with the fastening bores (11, 12) in the insulating rod (1), the contact (2) is fixed at both sides at the top and bottom respectively by an upper and a lower contact holder (3, 4) each pushed onto the insulating rod (1), each of the two contact holders (3, 4) has, at both sides, contact mounts (33, 34; 43, 44) each with a respective bore (37, 38; 47, 48), a respective limb (22, 23) of the contact (2) being received in each mount, and not only the contact (2), but also the two contact holders (3, 4) fixing it at both sides are fastened to the insulating rod (1) in common by two pins (5, 6) which horizontally penetrate the respective mutually corresponding fastening bores (11, 12) of the insulating rod (1), the fastening bores (25, 26; 27, 28) of the contact (2) and the bores (37, 38; 47, 48) of the respective contact holders (3, 4).

2. Contact arrangement according to claim 1, characterized in that each contact holder (3, 4) has a guide shank (31, 41) which surrounds the insulating rod (2) and at which is integrally formed an encircling collar (32, 42), at which the contact mounts (33, 34; 43, 44) are arranged opposite one another.

3. Contact arrangement according to claim 1, characterized in that respective counter-bearings (35, 36; 45, 46) for the pins (5, 6) are provided in the region of the contact mounts (33, 34; 43, 44).

4. Contact arrangement according to claim 3, characterized in that the outer regions of the counter-bearings (35, 36; 45, 46) are vertically displaced by a small amount relative to the respective corresponding fastening bore (11, 12) at the insulating rod (1) in such a manner that the respective inserted pin (5, 6) is axially fixed.

5. Contact arrangement according to claim 1, characterized in that upper contact holder (2) and lower contact holder (4) are identical components.

6. Contact arrangement according to claim 1, characterized in that in addition an upper and a lower screening cap (7, 8) are provided, the open sides of which each face the contact (2), each screening cap (7, 8) has lateral fastening straps (71, 72; 81, 82) with a respective bore (73, 74; 83, 84) and each screening cap (7, 8) is fastened to the insulating rod (1) in such a manner that each of the pins (6, 7) is additionally also guided through the respective corresponding bore (73, 74; 83, 84).

7. Contact arrangement according to claim 6, characterized in that the side edge of the fastening straps (71, 72; 81, 82) is held in lateral pockets (39, 49) of the respective contact holders (3, 4) by mechanically positive coupling.

8. Contact arrangement according to claim 6 or 7, characterized in that upper screening cap (7) and lower screening cap (8) are identical components.
